(19) United States
(12) Patent Application Publication
(10) Pub. No.: US 2026/0259700 A1
(43) Pub. Date: Sep. 3, 2026

(54) CODE GENERATION SUPPORT DEVICE, METHOD, AND NON-TRANSITORY COMPUTER-READABLE STORAGE MEDIUM

(71) Applicant: Keyence Corporation, Osaka (JP)

(72) Inventor: Kenya SUZUKI, Osaka (JP)

(73) Assignee: Keyence Corporation, Osaka (JP)

(21) Appl. No.: 19/452,443

(22) Filed: Jan. 19, 2026

(30) Foreign Application Priority Data
Feb. 28, 2025 (JP) 2025-031146

(51) Int. Cl. G06F 8/30; G01B 21/02; G06F 9/451

(52) U.S. Cl. CPC G06F 8/30; G01B 21/02; G06F 9/451

(57) ABSTRACT

A measurement setting work on shape data can be performed easily and appropriately. A code generation support device corrects shape data corresponding to each shape sensor of a plurality of shape sensors based on a correction value corresponding to a position and a posture of each shape sensor, and sets a measurement element and a measurement item. A text code for executing inspection of the measurement item using the measurement element is generated for the shape data. A display screen including a first display region that displays the measurement elements with the corrected shape data, and a second display region that displays a cross-sectional shape of the shape data is generated, and switching between a display aspect of simultaneously displaying, as display targets of the first display region, a plurality of pieces of shape data and a display aspect of displaying pieces of individual shape data.

### CROSS-REFERENCE TO RELATED APPLICATIONS

The present application claims foreign priority based on Japanese Patent Application No. 2025-031146, filed February 28, 2025, the contents of which are incorporated herein by reference.

### BACKGROUND OF THE INVENTION

### 1. Technical Field

The disclosure relates to a code generation support device, a computer-implemented method and a non-transitory computer-readable storage medium that support generation of a code for performing measurement processing on shape data obtained from a shape sensor that measures a shape of a measuring object.

### 2. Description of the Related Art

For example, JP2022-138028A discloses an optical displacement measurement system of a light cutting system.

The optical displacement measurement system disclosed in JP2022-138028A includes a light projection unit that irradiates a measuring object with slit light and a light reception unit that receives the slit light reflected from the measuring object. The measuring object is moved relative to the light projection unit and the light reception unit, and thus, a plurality of profiles is generated so as to correspond to positions in a moving direction. The plurality of generated profiles is composed to generate three-dimensional data indicating a three-dimensional shape of the measuring object.

The appearance inspection of the measuring object can be performed by using the optical displacement measurement system disclosed in JP2022-138028A. When the measuring object is measured and inspected by using the optical displacement measurement system, it is necessary to appropriately process shape data. In order to appropriately process the shape data, it is conceivable to use dedicated application software corresponding to the optical displacement measurement system.

Incidentally, for example, in a case where a plurality of types of devices and the like are composed, it may be difficult to use the dedicated application software. Therefore, for example, a user needs to create a unique program for each device related to the composition, but it is not easy to create an appropriate processing program for every measurement content for the shape data representing the three-dimensional shape.

In addition, since many measuring objects have a three-dimensional shape, it is conceivable to easily grasp the shape of the measuring object by measuring the measuring object from a plurality of directions by not only one shape sensor but also a plurality of shape sensors.

However, in a case where the measuring object is measured from the plurality of directions by the plurality of shape sensors, a plurality of pieces of shape data corresponding to the plurality of shape sensors is acquired, and thus, how to present the shape data to the user is a problem.

### SUMMARY OF THE INVENTION

An object of the disclosure is to provide a code generation support device and a code generation support program capable of easily and appropriately performing a measurement setting work on pieces of shape data obtained from a plurality of shape sensors.

In order to achieve the above object, in one embodiment of the disclosure, a code generation support device of an inspection device can be assumed. A code generation support device of an inspection device includes a reception unit that receives pieces of shape data, a correction unit that corrects each piece of shape data corresponding to each shape sensor of a plurality of shape sensors such that each piece of shape data becomes a common coordinate system based on a correction value corresponding to a position and a posture of each shape sensor, a setting unit that sets one or more measurement elements and a measurement item using the one or more measurement elements, an execution unit that specifies the one or more measurement elements set by the setting unit for the shape data received by the reception unit, and executes inspection of the measurement item using the one or more measurement elements set by the setting unit, and a code generation unit that specifies the one or more measurement elements for the shape data, and generates a text code for executing the inspection of the measurement item using the one or more measurement elements, and a screen generation unit that generates a display screen including a first display region that two-dimensionally and/or three-dimensionally displays the shape data corrected to the common coordinate system by the correction unit and displays the one or more measurement elements on the shape data, and a second display region that displays a cross-sectional shape of the shape data, the display screen being capable of switching between a display aspect of simultaneously displaying, as display targets of the first display region, a plurality of pieces of shape data corresponding to the plurality of shape sensors and a display aspect of displaying pieces of individual shape data among the plurality of pieces of shape data.

According to this configuration, when each of the plurality of shape sensors acquires the shape data, the shape data corresponding to each shape sensor is corrected by the correction unit such that each shape data becomes the common coordinate system. The measurement element is specified for the shape data, and the inspection of the measurement item is executed. Since the text code for executing the inspection of the measurement item is generated by the code generation unit, the user does not need to create a unique program, and a measurement setting work becomes easy.

In addition, the shape data corrected to the common coordinate system by the correction unit can be two-dimensionally and/or three-dimensionally displayed, the measurement element can be displayed on the shape data, and the cross-sectional shape of the shape data can also be displayed. In addition, it is also possible to switch between the display aspect of simultaneously displaying the plurality of pieces of shape data corresponding to the plurality of shape sensors and the display aspect of displaying the pieces of individual shape data among the plurality of pieces of shape data.

In addition, in another embodiment of the disclosure, a code generation support program can be assumed. A code generation support program can cause a computer to execute processing of receiving pieces of shape data, processing of correcting shape data corresponding to each shape sensor of a plurality of shape sensors based on a correction value corresponding to a position and a posture of each shape sensor, processing of setting one or more measurement elements and a measurement item using the one or more measurement elements, processing of specifying the set one or more measurement elements for the received shape data and executing inspection of the measurement item using the set one or more measurement elements, processing of specifying the one or more measurement elements for the shape data and generating a text code for executing the inspection of the measurement item using the one or more measurement elements, and processing of generating a display screen including a first display region that two- dimensionally and/or three-dimensionally displays the corrected shape data, and displays the one or more measurement elements on the shape data, and a second display region that displays a cross-sectional shape of the shape data, the display screen being capable of switching between a display aspect of simultaneously displaying, as display targets of the first display region, a plurality of pieces of shape data corresponding to the plurality of shape sensors and a display aspect of displaying pieces of individual shape data among the plurality of pieces of shape data.

According to the technology of the disclosure, it is possible to easily and appropriately perform the measurement setting work on the pieces of shape data obtained from the plurality of shape sensors.

### BRIEF DESCRIPTION OF THE DRAWINGS

FIG. 1 is a diagram for explaining an outline of configurations of a main measurement system and a sub-measurement system according to the present embodiment;

FIG. 2 is a diagram for describing a relationship between a text code and a library;

FIG. 3 is a block diagram illustrating a configuration of a main measurement device;

FIG. 4 is a flowchart illustrating a flow from taking of shape data to code generation processing;

FIG. 5 is a flowchart illustrating a flow of an operation required by a user;

FIG. 6 is a diagram illustrating an example of a screen displayed on a display unit in a first phase;

FIG. 7 is a diagram illustrating an example of an installation state of a plurality of measurement heads;

FIG. 8 is a diagram illustrating an example of an image composition screen;

FIG. 9 is a diagram illustrating an example of a connection setting screen;

FIG. 10 is a diagram illustrating an example of an alignment screen displayed when alignment is executed;

FIG. 11 is a diagram illustrating an example of an image acquisition screen;

FIG. 12 is a diagram illustrating an example of an image composition setting screen;

FIG. 13 is a diagram illustrating an example of a main screen;

FIG. 14 is a diagram illustrating an example of a main screen in a state where a measurement element and a measurement item are set;

FIG. 15 is a diagram illustrating an example of a text code generation window;

FIG. 16 is a diagram illustrating an example of an information output window;

FIG. 17 is a diagram illustrating an example of a text code display window;

FIG. 18 is a flowchart illustrating a flow of text code generation processing; and

FIG. 19 is a block diagram illustrating a configuration of a sub-measurement device.

### DETAILED DESCRIPTION

Hereinafter, embodiments of the invention will be described in detail with reference to the drawings. Note that, the following description of preferred embodiments is merely exemplary in nature and is not intended to limit the invention, the application thereof, or the use thereof. For example, a relative size and a positional relationship of each member illustrated in the drawings are for describing one embodiment, and do not limit the invention.

A code generation support device according to the embodiment of the invention is incorporated in, for example, a measurement system that measures a shape of a measuring object W. In addition, the code generation support device is used to support a setting work of a measurement device included in another measurement system such that the shape of the measuring object W is measured in the other measurement system. In the description of the present embodiment, a measurement system including a configuration of the code generation support device is referred to as a main measurement system, and another measurement system including a support target (measurement device) of the setting work is referred to as a sub-measurement system.

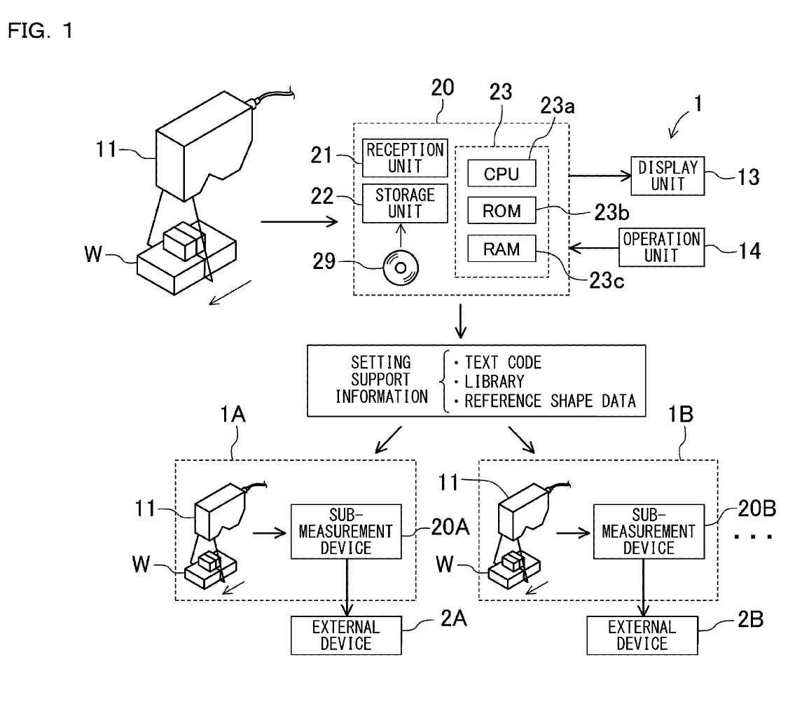

As illustrated in FIG. 1, the main measurement system 1 according to the present embodiment can measure shapes of a plurality of measuring objects W sequentially conveyed by a conveyance device such as a belt conveyor and inspect the measuring objects W. The main measurement system 1 includes a measurement head 11, which is an example of a shape sensor, a display unit 13, an operation unit 14, and a main measurement device 20. The shape sensor is not limited to the measurement head 11, and may be, for example, a three-dimensional profiler or a three-dimensional image sensor.

The measurement head 11 is installed so as to face a surface to be measured of the measuring object W. The measurement head 11 includes a light projection unit and a light reception unit (not illustrated). The light projection unit of the measurement head 11 emits strip- shaped measurement light extending in one direction toward the measuring object W conveyed by the conveyance device. The light reception unit of the measurement head 11 receives the measurement light reflected by the measuring object W and outputs a light reception amount distribution. The light reception unit of the measurement head 11 is connected to the main measurement device 20. In the main measurement device 20, shape data indicating a three-dimensional shape of the measuring object W is generated based on the light reception amount distribution output from the measurement head 11.

The shape data indicating the three-dimensional shape of the measuring object W includes plane positional information according to a plane coordinate system determined in advance for the measurement head 11 and height information corresponding to each plane position in the plane coordinate system. The shape data indicating the three-dimensional shape of the measuring object W can also include XY coordinates of each point sequence arrayed in a lattice shape and a Z coordinate corresponding to each point sequence, as the plane positional information according to the plane coordinate system. Since the point sequences in the shape data indicating the three-dimensional shape of the measuring object W are arrayed in a lattice shape, the point sequences are arrayed at an equal pitch in an X direction and are also arrayed at an equal pitch in a Y direction. At this time, the pitch in the X direction and the pitch in the Y direction may be the same or different. Note that, the shape data indicating the three-dimensional shape of the measuring object W may include luminance information and the like corresponding to each plane position in addition to the plane positional information and the height information.

The main measurement device 20 is an example of the code generation support device according to the embodiment of the invention. The main measurement device 20 includes, for example, a personal computer, and includes a reception unit 21, a storage unit 22, and a control unit 23. The reception unit 21 includes, for example, various communication interfaces, a memory, and the like, and is a portion that receives the shape data of the measuring object W output from the measurement head 11. Specifically, the reception unit 21 receives the light reception amount distribution output from the measurement head 11, generates profile data from the received light reception amount distribution, and temporarily stores the generated profile data.

The storage unit 22 includes, for example, a recording medium such as a nonvolatile memory or a hard disk. The storage unit 22 stores a code generation support program according to the embodiment of the invention. The code generation support program is a program that generates and outputs setting support information for supporting various setting works of sub-measurement devices 20A, 20B,... to be described later.

The storage unit 22 also stores, for example, inspection data and the like. The inspection data includes, for example, a text code, a library, a reference image, correction data, and the like. The storage unit that stores the inspection data and the storage unit that stores the code generation support program may be different.

The control unit 23 includes, for example, a central processing unit (CPU) 23a, a read only memory (ROM) 23b, a random access memory (RAM) 23c, and the like. The RAM 23c is used as a work region when the CPU 23a of the control unit 23 operates. The ROM 23b stores, for example, a system program. The CPU 23a executes the code generation support program stored in the storage unit 22, and thus, a plurality of types of processing is executed by the personal computer. That is, the code generation support program is a program for causing a computer to execute a plurality of types of processing. When the CPU 23a executes the code generation support program, various functional units for generating the setting support information are realized. Note that, the code generation support program may not be stored in the storage unit 22, and may be stored in the ROM 23b of the control unit 23. In addition, the code generation support program may be provided in a state of being stored in a recording medium 29 such as a CD-ROM or a USB memory. In this case, the code generation support program stored in the recording medium 29 can be installed and used in the storage unit 22 or the ROM 23b. In addition, the code generation support program may be installed in an external server, and in this case, the external server may also be an element constituting a part of the code generation support device.

The display unit 13 includes, for example, an organic electroluminescence (EL) panel, a liquid crystal display (LCD) panel, or the like. The display unit 13 is connected to the main measurement device 20. The display unit 13 may or may not be included in the main measurement device 20. In addition, the operation unit 14 includes, for example, a keyboard and a pointing device such as a mouse. The operation unit 14 includes a device operated by a user, and is connected to the main measurement device 20. The main measurement device 20 detects an operation status by the operation unit 14, and reflects the operation status in each processing.

FIG. 1 illustrates a plurality of sub-measurement systems 1A, 1B,.... Since the plurality of sub-measurement systems 1A, 1B,... have the same configuration, the configuration of the sub-measurement system 1A will be described below.

The sub-measurement system 1A includes a measurement head 11 and the sub-measurement device 20A. The measurement head 11 of the sub-measurement system 1A has the same configuration as the measurement head 11 of the main measurement system 1. The sub-measurement device 20A can include a personal computer similar to the main measurement device 20. Note that, the code generation support program is not stored in a storage unit of the sub-measurement device 20A.

The main measurement device 20 generates and outputs the setting support information based on an operation of the user by executing the code generation support program. Various settings related to the measurement of the measuring object W are performed in the sub-measurement device 20A by using the setting support information output from the main measurement device 20 of the main measurement system 1. In the sub-measurement device 20A after the setting using the setting support information, predetermined measurement or inspection on the shape of the measuring object W is executed based on the shape data obtained from the measurement head 11.

The sub-measurement device 20A is connected to an external device 2A. The external device 2A includes, for example, a programmable logic controller (PLC). A measurement result or an inspection result by the sub-measurement device 20A is transmitted to the external device 2A. Similarly to the sub-measurement device 20A, an external device 2B is also connected to the sub-measurement device 20B.

The setting support information generated by the main measurement device 20 includes a text code (source code), a library, reference shape data, and correction data. The text code is data generated by the main measurement device 20 based on the operation of the user. The library is, for example, data prepared in advance by a manufacturer of the main measurement device 20. The reference shape data is mainly the shape data of the measuring object W used when the text code is generated in the main measurement device 20.

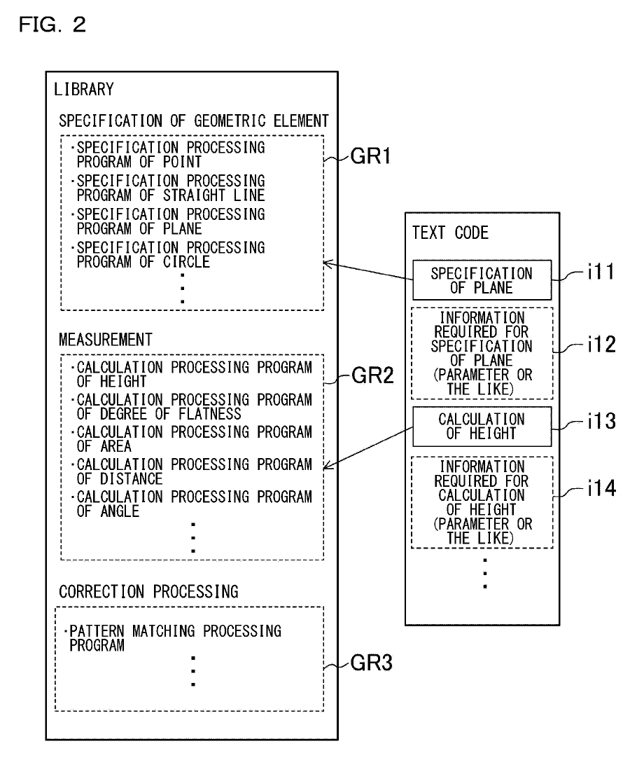

Here, an outline of a relationship between the text code and the library will be described with reference to FIG. 2. FIG. 2 is a diagram for describing the relationship between the text code and the library. The library includes a plurality of processing programs capable of appropriately performing a plurality of types of predetermined processing on the shape data of the measuring object W. The library may be provided in the form of, for example, a dynamic link library (DLL) file. The plurality of processing programs of the library of this example includes processing programs classified into three groups (first group GR1, second group GR2, and third group GR3). Note that, since the text code can be easily modified by the user, for example, it is easy to use a plurality of different types of measurement devices, image processing devices, and the like in composition in order to execute inspection.

The plurality of processing programs classified into the first group GR1 is used to specify portions of a plurality of types of geometric shapes from the shape data of the measuring object W, and is present for every type (geometric element) of the geometric shape. The geometric element includes, for example, a point, a straight line, a plane, a circle, and the like. In the example illustrated in FIG. 2, "specification processing program of point", "specification processing program of straight line", "specification processing program of plane", and the like are exemplified.

The plurality of processing programs classified into the second group GR2 is used to perform a plurality of types of measurements on the shape of the measuring object W from the shape data of the measuring object W, and is for every type of measurement (measurement item). The measurement item includes, for example, height, a degree of flatness, area, distance, angle, and the like. In the example illustrated in FIG. 2, "calculation processing program of height", "calculation processing program of degree of flatness", "calculation processing program of area", and the like are exemplified.

The plurality of processing programs classified into the third group GR3 is used for position correction of the shape data of the measuring object W by a plurality of types of methods, and is for every position correction method. The position correction method includes a correction method based on pattern matching. In the example illustrated in FIG. 2, "pattern matching processing program" is exemplified. The position correction includes correction of a position in the plane coordinate system. In addition, the position correction may include correction of a rotational posture in the plane coordinate system in addition to the correction of the position in the plane coordinate system. In addition, the position correction may include correction of a position in a height coordinate system corresponding to the height information in addition to the correction of the position in the plane coordinate system. Further, the position correction may include correction of an attitude (three-dimensional attitude) in a three-dimensional coordinate system including a plane coordinate system and a height coordinate system. Note that, the number of processing programs classified into the third group GR3 may be one.

The text code includes character information (processing program information to be described later) indicating a processing program to be called from the library in order to specify one or a plurality of geometric elements from the shape data or perform one or a plurality of measurements. This character information can also be referred to as information indicating "function" required for processing for specifying one or a plurality of geometric elements or performing one or a plurality of measurements.

In addition, the text code includes character information (designation information to be described later) indicating a parameter or the like necessary for specifying one or a plurality of geometric elements or performing one or a plurality of measurements. This character information can also be referred to as information indicating "argument" associated with the above "function" for specifying one or a plurality of geometric elements or performing one or a plurality of measurements. In the example illustrated in FIG. 2, "specification of plane", "information required to specify plane", "calculation of height", and "information required to calculate height" are illustrated as pieces of character information i11, i12, i13, and i14 included in the text code.

According to the text code, the character information i11 of "specification of plane" is read, and thus, "specification processing program of plane" can be selected and called from the plurality of processing programs in the library. In addition, it is possible to specify a desired plane portion of the measuring object W based on the called "specification processing program of plane" and the character information i12 including contents of "information required to specify plane".

Further, according to the text code, the character information i13 of "calculation of height" is read, and thus, "calculation processing program of height" can be selected and called from the plurality of processing programs in the library. In addition, a height of a desired portion of the measuring object W can be measured from the shape data of the measuring object W based on the called "calculation processing program of height " and the character information i14 including the contents of "information required to calculate height".

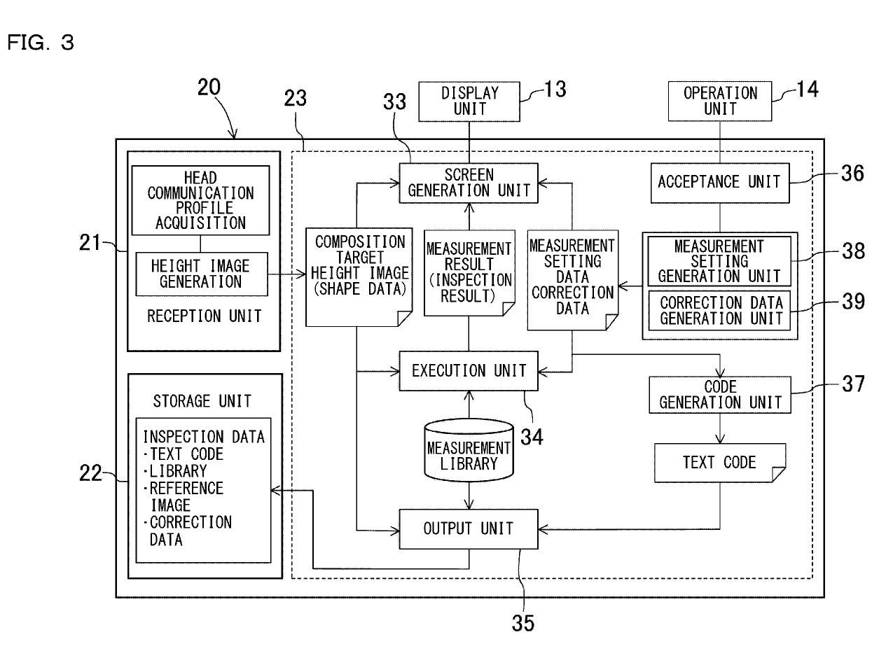

FIG. 3 is a block diagram of the main measurement device 20 of the main measurement system 1. The main measurement device 20 of the main measurement system 1 includes a screen generation unit 33, an execution unit 34, an output unit 35, an acceptance unit 36, a code generation unit 37, a measurement setting generation unit 38, and a correction data generation unit 39. The screen generation unit 33, the execution unit 34, the output unit 35, the acceptance unit 36, the code generation unit 37, the measurement setting generation unit 38, and the correction data generation unit 39 are realized by the CPU 23a (illustrated in FIG. 1) of the control unit 23 executing the code generation support program stored in the storage unit 22. In a case where the code generation support program includes a plurality of program modules, each of the screen generation unit 33, the execution unit 34, the output unit 35, the acceptance unit 36, the code generation unit 37, the measurement setting generation unit 38, and the correction data generation unit 39 may include a single program module or a plurality of program modules. A part or all of the screen generation unit 33, the execution unit 34, the output unit 35, the acceptance unit 36, the code generation unit 37, the measurement setting generation unit 38, and the correction data generation unit 39 may include hardware, or may include a composition of hardware and software.

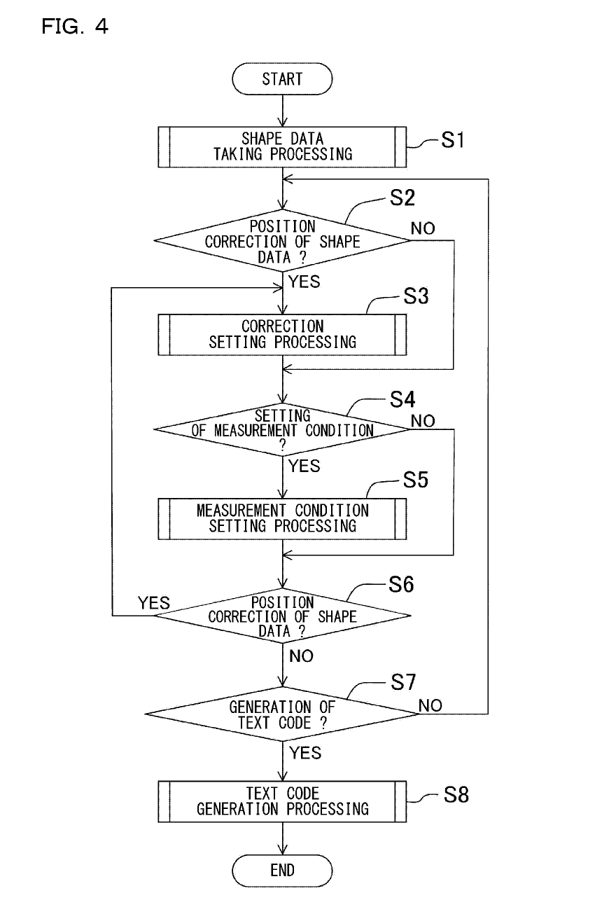

FIG. 4 is a flowchart illustrating a flow from the taking of the shape data to the execution of the code generation processing by the main measurement system 1. In step S1, the main measurement system 1 sequentially measures the shapes of the plurality of measuring objects W conveyed by, for example, the conveyance device in which an encoder is provided. That is, the reception unit 21 of the main measurement system 1 can grasp a movement distance in a conveyance direction of each measuring object W conveyed by the conveyance device based on the output from the encoder of the conveyance device. The reception unit 21 receives the profile data (hereinafter, also referred to as shape data) output from the measurement head 11 of the shape sensor whenever each measuring object W moves by a predetermined distance (a set pitch) based on the output from the encoder of the conveyance device. This processing is processing of receiving the shape data, and is executed by the computer by the code generation support program. The reception unit 21 generates a height image from the plurality of pieces of received profile data. Here, the height image is shape data in which each of pixels two-dimensionally arrayed on a reference plane has a height in a reference plane vertical direction as a pixel value. A height direction is set in advance for the measurement head 11 of the shape sensor. Accordingly, shape data such as profile data and a height image is represented in a local coordinate system for every shape sensor. The height image generated by the reception unit 21 is a composition target height image. The composition target height image is transmitted from the reception unit 21 to the screen generation unit 33, the execution unit 34, and the output unit 35. Note that, the reception unit 21 may generate point cloud data in which each point constituting the shape data has any three-dimensional space coordinates from the plurality of pieces of received profile data.

Note that, in addition to the profile data output from the measurement head 11, the reception unit 21 can also receive, for example, profile data output from a three-dimensional profiler, profile data output from a three-dimensional image sensor, three-dimensional CAD data, and the like to generate the height image. The profile data output from the three-dimensional profiler, the profile data output from the three-dimensional image sensor, the three-dimensional CAD data, and the like are also included in the shape data.

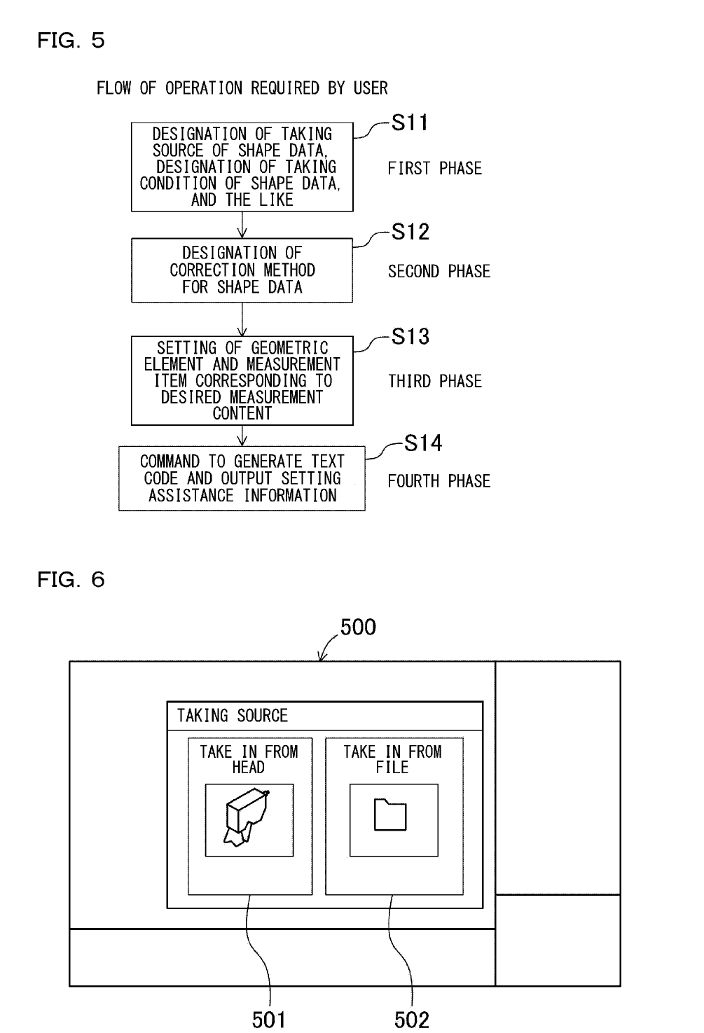

FIG. 5 is a flowchart illustrating a flow of an operation required by the user when the main measurement system 1 executes code generation processing from the taking of the shape data. In step S11, the user designates a taking source of the shape data, designates a taking condition of the shape data, and the like. This phase is referred to as a first phase.

In the first phase, the screen generation unit 33 generates a taking source designation screen 500 illustrated in FIG. 6 and displays the taking source designation screen on the display unit 13. A first button 501 for taking in the shape data output from the measurement head 11 and a second button 502 for taking in the shape data from a file saved in the storage unit 22 or the like, as buttons for designating the taking source of the shape data are provided on the taking source designation screen 500. When the user operates the first button 501, the reception unit 21 takes in the shape data output from the measurement head 11. On the other hand, when the user operates the second button 502, the reception unit 21 takes in the shape data from the file. This taking processing is processing executed in step S1 of the flowchart illustrated in FIG. 4.

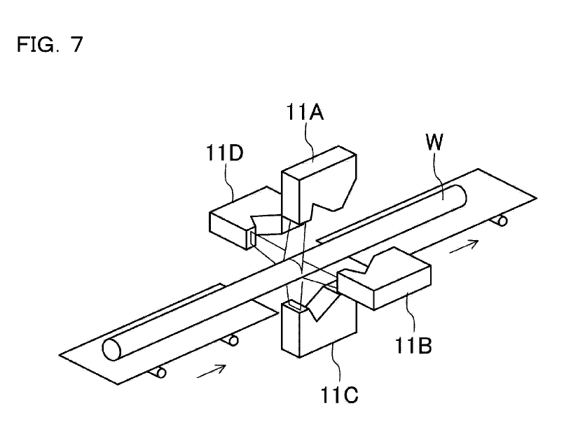

In step S2, it is determined whether or not the main measurement system 1 performs position correction of the shape data. That is, for example, as illustrated in FIG. 7, when a columnar measuring object W is conveyed in an axial direction by the conveyance device, the shape data of the measuring object W may be measured by the first measurement head 11A of the shape sensor, the second measurement head 11B of the shape sensor, the third measurement head 11C of the shape sensor, and the fourth measurement head 11D of the shape sensor. The first measurement head 11A, the second measurement head 11B, the third measurement head 11C, and the fourth measurement head 11D are installed at any intervals, for example, at equal intervals in a circumferential direction of the measuring object W so as to surround the periphery of the measuring object W. With such an installation state, a shape of the entire circumference of the measuring object W can be measured by the first measurement head 11A, the second measurement head 11B, the third measurement head 11C, and the fourth measurement head 11D.

When the measuring object W is measured by using the plurality of measurement heads 11A to 11D, it is necessary to correct the coordinate system of the shape data corresponding to each of the measurement heads 11A to 11D. This processing is processing of correcting the shape data corresponding to each of the measurement heads 11A to 11D such that the coordinate system of each piece of shape data is common based on a correction value corresponding to a position and a posture of each of the measurement heads 11A to 11D of the plurality of shape sensors, and is executed by the computer by the code generation support program. The correction data generation unit 39 generates correction data in which the height direction and an orientation in the reference plane of each piece of shape data correspond to a posture of each shape sensor corresponding to each piece of shape data in common coordinates. In addition, the correction data generation unit 39 generates correction data in which an origin position of each piece of shape data corresponds to a position of each shape sensor corresponding to each piece of shape data in common coordinates. The correction data generation unit 39 can generate correction data for handling pieces of shape data having different height directions in common coordinates as well as the origin position and the orientation in the reference plane. The pieces of shape data having the different height directions are composed, and thus, the shape of the entire circumference can be obtained from profile data or a height image having only a single value in the height direction.

Specifically, in step S12 of the flowchart illustrated in FIG. 5, the user designates a correction method for the shape data to be taken in. An operating stage of the main measurement device 20 by the user at this time is referred to as a second phase. At a stage when the first phase is completed, the processing proceeds to the second phase.

In step S2 of the flowchart illustrated in FIG. 4, the main measurement system 1 determines whether or not the correction method for the shape data is designated in the second phase. In a case where the correction method for the shape data is not designated, step S3 is skipped, and the processing proceeds to step S4. In a case where the correction method for the shape data is designated, the processing proceeds to step S3.

In step S3, the correction data generation unit 39 of the main measurement system 1 executes correction setting processing by using an alignment tool. The correction data generation unit 39 is a portion that corrects the shape data corresponding to each measurement head 11 based on the correction value corresponding to the position and posture of each measurement head 11 of the plurality of measurement heads 11, and uses the alignment tool in the correction.

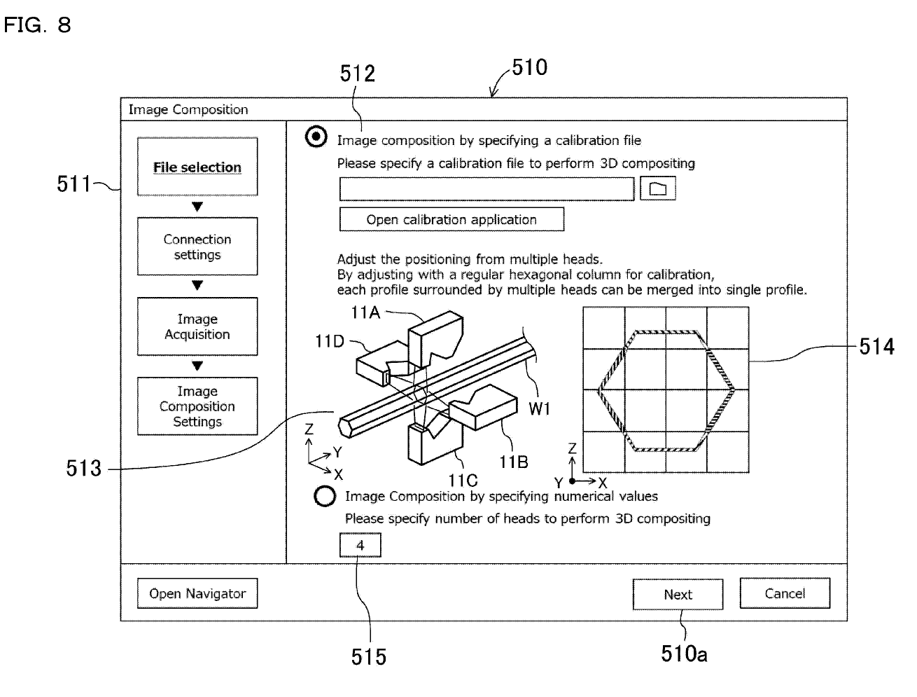

FIG. 8 illustrates an image composition screen 510 displayed on the display unit 13 in a case where the shape data corresponding to each of the measurement heads 11A to 11D is corrected by using the alignment tool. The image composition screen 510 is generated by the screen generation unit 33 and displayed on the display unit 13.

A procedure display region 511 in which a processing procedure is displayed, an alignment file selection region 512, an image display region 513 in which a measurement image is displayed, a profile display region 514, and a head number designation region 515 for designating the number of measurement heads 11 used for image composition are provided on the image composition screen 510.

Since the example illustrated in FIG. 8 illustrates processing of selecting an alignment file, "file selection" is emphasized and displayed in the procedure display region 511. In the alignment file selection region 512, the user can select a desired alignment file and accept an operation of opening the selected alignment file by operating the operation unit 14. The correction data generation unit 39 executes processing of opening the alignment file selected in the alignment file selection region 512.

The alignment file can be generated by executing the alignment tool. When the alignment tool is executed, a workpiece W1 for alignment of a regular hexagonal prism is prepared as displayed in the image display region 513, and the first measurement head 11A, the second measurement head 11B, the third measurement head 11C, and the fourth measurement head 11D of the plurality of shape sensors are installed so as to surround the periphery of the workpiece W1 for alignment. Installation positions of the first measurement head 11A, the second measurement head 11B, the third measurement head 11C, and the fourth measurement head 11D are installation positions at the time of operation.

In the profile display region 514, an image obtained by composing the pieces of shape data measured by the first measurement head 11A, the second measurement head 11B, the third measurement head 11C, and the fourth measurement head 11D is displayed. This image is generated by the correction data generation unit 39.

In the head number designation region 515, the user can input the number of measurement heads 11 to be used for composing the pieces of shape data by operating the operation unit 14. In this example, since a case where the pieces of shape data measured by the four measurement heads 11, that is, the first measurement head 11A, the second measurement head 11B, the third measurement head 11C, and the fourth measurement head 11D are composed is illustrated, "4" is input. The input number is acquired by the correction data generation unit 39.

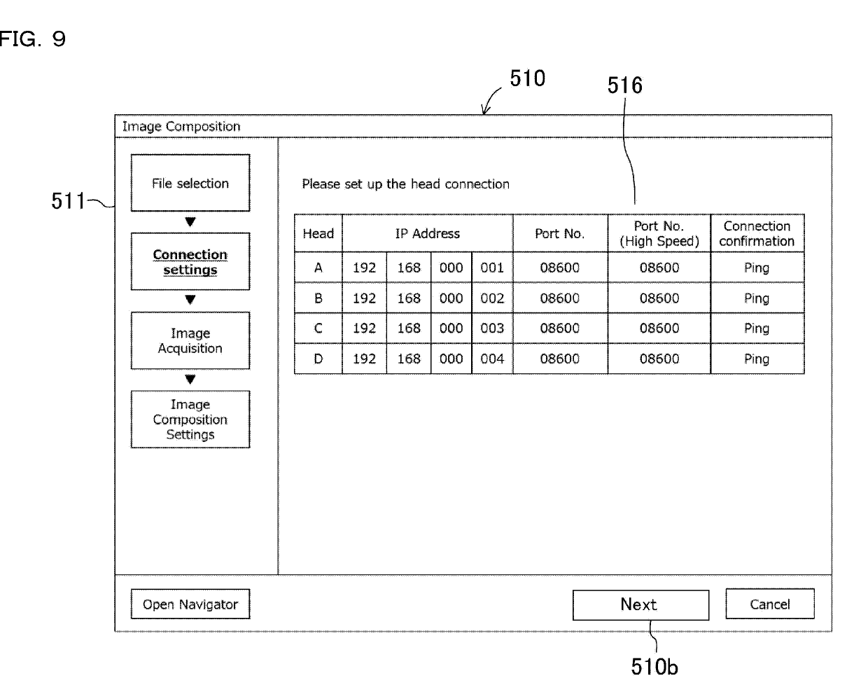

FIG. 9 illustrates a state where the processing proceeds to "connection settings" after "file selection". When the user operates a Next button 510a in FIG. 8, the processing proceeds from "file selection" to "connection settings". In the procedure display region 511, "connection settings" is emphasized and displayed. In the connection settings, a connection setting screen 516 is generated by the screen generation unit 33 and displayed on the display unit 13. On the connection setting screen 516, the four measurement heads 11A, 11B, 11C, and 11D are indicated by "A", "B", "C", and "D", respectively. On the connection setting screen 516, it is possible to set an IP address, set a port number, and input connection information for each of the four measurement heads 11A, 11B, 11C, and 11D. In addition, on the connection setting screen 516, it may be possible to input an installation angle for each of the four measurement heads 11A, 11B, 11C, and 11D. The information set on the connection setting screen 516 is acquired by the correction data generation unit 39.

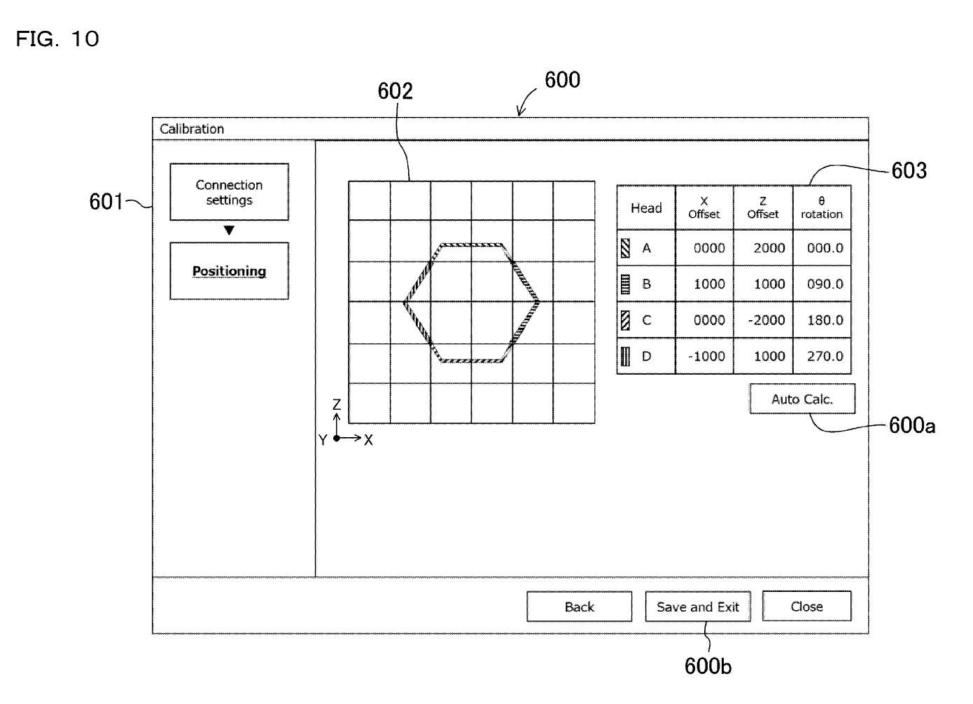

Here, alignment file generation processing will be described. The alignment file generation processing is processing in the second phase of step S12 illustrated in FIG. 5. FIG. 10 is a diagram illustrating an example of an alignment screen 600 displayed when alignment is executed. The alignment screen 600 is generated by the screen generation unit 33 and displayed on the display unit 13. An alignment procedure display region 601 in which a procedure of alignment processing is displayed, a profile display region 602, and a correction value display region 603 are provided on the alignment screen 600.

In the profile display region 602, an image obtained by composing the pieces of shape data measured by the first measurement head 11A, the second measurement head 11B, the third measurement head 11C, and the fourth measurement head 11D used for combining is displayed. This image is generated by the correction data generation unit 39.

In the correction value display region 603, a correction value corresponding to the position and posture of each of the measurement heads 11A, 11B, 11C, and 11D of the plurality of measurement heads 11A, 11B, 11C, and 11D is displayed. The alignment screen 600 including the correction value display region 603 for displaying the correction value is an example of a correction value display screen.

The correction value is calculated by the correction data generation unit 39. For example, a length of each side of the alignment workpiece W1 is known, and since the alignment workpiece W1 is the regular hexagonal prism, an angle formed by two adjacent sides is also known. The correction data generation unit 39 acquires geometric information of the alignment workpiece W1.

The correction data generation unit 39 acquires the shape data measured by each of the measurement heads 11A, 11B, 11C, and 11D. Based on the geometric information of the alignment workpiece W1, the correction data generation unit 39 calculates a correction value of a positional relationship among the measurement heads 11A, 11B, 11C, and 11D such that the pieces of shape data measured by the measurement heads 11A, 11B, 11C, and 11D coincide with the shape of the alignment workpiece W1. Specifically, the correction data generation unit 39 calculates an offset value in the X direction, an offset value in the Z direction, and a θ angle of each of the measurement heads 11A, 11B, 11C, and 11D. This calculation processing is executed at a timing when an automatic calculation button 600a provided on the alignment screen 600 is operated by the user. After the correction data generation unit 39 calculates the correction value corresponding to the position and posture of each of the measurement heads 11A, 11B, 11C, and 11D using the alignment tool, each calculated correction value is displayed in the correction value display region 603. The correction data generation unit 39 automatically corrects the shape data corresponding to each of the measurement heads 11A, 11B, 11C, and 11D based on the calculated correction value.

The correction data generation unit 39 accepts adjustment of the correction value displayed in the correction value display region 603. For example, in a case where the accuracy of positioning is low as a result of automatic correction, when the user operates the operation unit 14 to execute an operation of adjusting the correction value displayed in the correction value display region 603, the correction value that reflects the adjustment is displayed in the correction value display region 603. Then, the correction data generation unit 39 acquires the correction value after the adjustment. Since the acquired adjusted correction value is used in each processing, the correction data generation unit 39 can confirm whether or not the accuracy of positioning is improved with the correction value adjusted by the user.

The correction data generation unit 39 is configured to be able to write the calculated correction value as a binary. Data including the calculated correction value is defined as correction data. A save button 600b is provided on the alignment screen 600. When the save button 600b is operated, the correction data generation unit 39 writes the correction data as data to be used together with the output code. The output code written by the correction data generation unit 39 can be saved in the storage unit 22 or can be saved in the external device, for example. This output code is the alignment file.

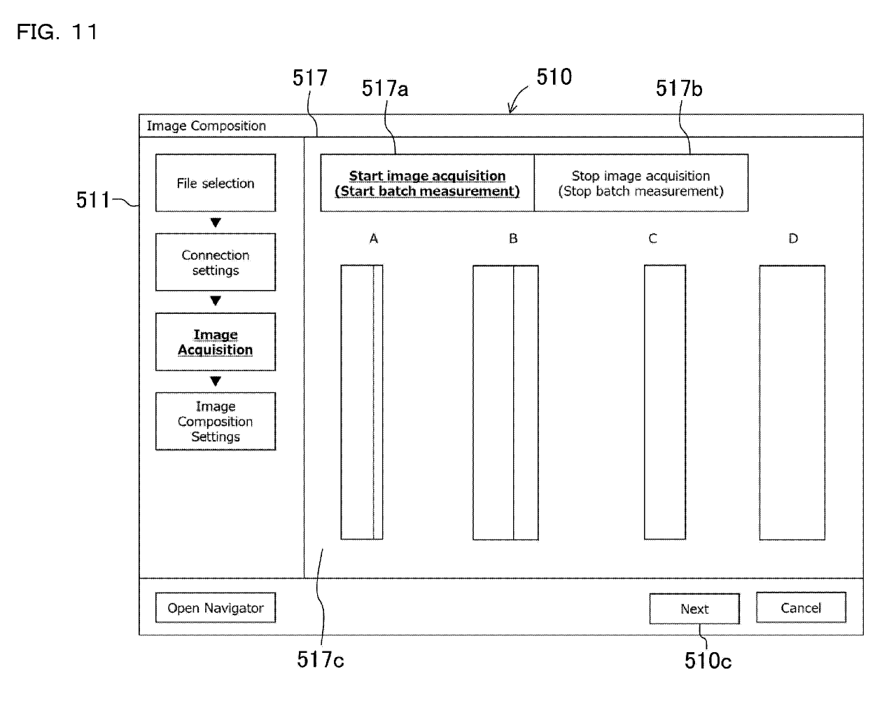

FIG. 11 illustrates a state where the processing proceeds to "image acquisition" after "connection settings". When the user operates a Next button 510b in FIG. 9, the processing proceeds from "connection settings" to "image acquisition". "Image" corresponds to the shape data. In the procedure display region 511, "image acquisition" is emphasized and displayed. In the image acquisition, an image acquisition screen 517 is generated by the screen generation unit 33 and displayed on the display unit 13. An image acquisition start button 517a for starting the acquisition of the shape data, an image acquisition stop button 517b for stopping the acquisition of the shape data, and a shape data display region 517c are provided on the image acquisition screen 517.

When the image acquisition start button 517a is operated, the pieces of shape data acquired by the first measurement head 11A, the second measurement head 11B, the third measurement head 11C, and the fourth measurement head 11D of the plurality of shape sensors are displayed in the shape data display region 517c. Here, the shape data such as the profile data and the height image obtained by using the shape sensor has a single height data at each measurement point on a reference straight line or a reference plane, but only a measurement point at which valid height data is obtained may be displayed in the shape data display region 517c. The valid height data refers to, for example, height data obtained by removing a background or the like in data of a height range in which a measuring object is present, height data determined to be normal in comparison with pieces of height data at surrounding measurement points, height data obtained when the shape sensor is an optical sensor and a measurement light amount is sufficient, and the like. The shape data display region 517c is divided into four regions, and the pieces of shape data acquired by the first measurement head 11A, the second measurement head 11B, the third measurement head 11C, and the fourth measurement head 11D can be displayed separately. As a result, it is possible to confirm each piece of shape data acquired by each of the first measurement head 11A, the second measurement head 11B, the third measurement head 11C, and the fourth measurement head 11D.

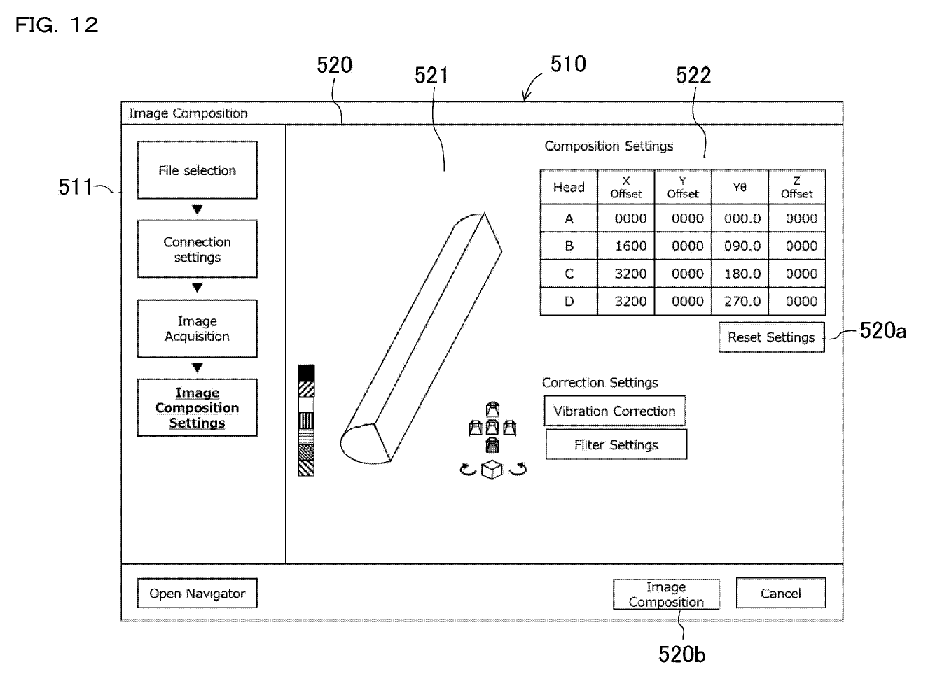

FIG. 12 illustrates a state where the processing proceeds to "image composition settings" after "image acquisition". When the user operates a Next button 510c in FIG. 11, the processing proceeds from "image acquisition" to "image composition settings". In the procedure display region 511 of FIG. 12, "image composition settings" is emphasized and displayed. In the image composition settings, an image composition setting screen 520 is generated by the screen generation unit 33 and displayed on the display unit 13.

A composition image display region 521 and a composition setting display region 522 are provided on the image composition setting screen 520. In the composition image display region 521, a composition image obtained by composing a plurality of pieces of shape data displayed in the shape data display region 517c of FIG. 11 is displayed. The composition image is an image based on the shape data corrected by the correction data generation unit 39, and is generated by the screen generation unit 33. In the composition setting display region 522, an offset value in the X direction, an offset value in the Y direction, a θ angle, and an offset value in the Z direction of each of the first measurement head 11A, the second measurement head 11B, the third measurement head 11C, and the fourth measurement head 11D are displayed as setting values of the image composition. When a reset button 520a provided on the image composition setting screen 520 is operated, the setting values of the image composition are reset.

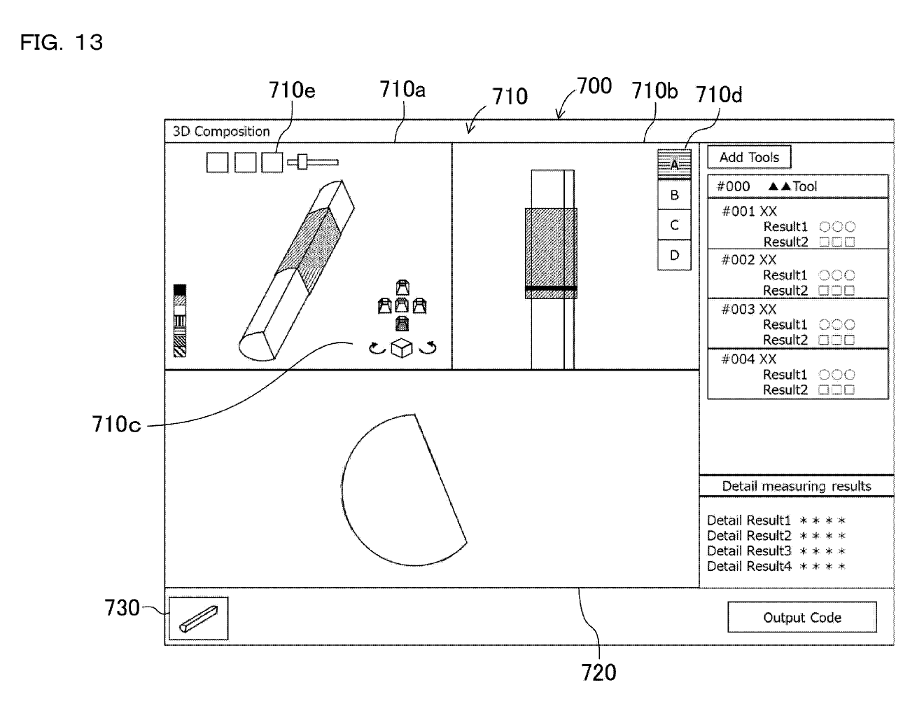

When the user operates an image composition button 520b provided on the image composition setting screen 520, a main screen (display screen) 700 illustrated in FIG. 13 is generated by the screen generation unit 33 and displayed on the display unit 13. The main screen 700 includes a first display region 710 and a second display region 720. The first display region 710 is a region for two-dimensionally and/or three-dimensionally displaying the shape data corrected by the correction data generation unit 39. The first display region 710 and the second display region 720 may be arranged in an up-down direction as illustrated in FIG. 13, or may be arranged in a left-right direction although not illustrated.

The first display region 710 according to the present embodiment includes a shape data display section 710a that displays shape data and an individual image display section 710b that displays shape data measured by each measurement head 11. The shape data display section 710a and the individual image display section 710b may be arranged in the up-down direction as illustrated in FIG. 13, or may be arranged in the left-right direction although not illustrated.

In the shape data display section 710a, the shape data corrected by the correction data generation unit 39 is displayed two-dimensionally and/or three-dimensionally. An adjustment section 710c for adjusting a line-of-sight direction (view) of the shape data to be displayed is provided in the shape data display section 710a. Since the line-of-sight direction of the shape data is adjusted and displayed in the shape data display section 710a so as to be a view adjusted in the adjustment section 710c, the user can view the shape data of the measuring object W from a desired direction.

The shape data displayed in the shape data display section 710a can be, for example, point cloud data including a large number of point clouds. In this case, an image is obtained by changing a color of each point depending on a height. As a result, the user can grasp a relative height of each part in the shape data.

A switch button 710e for switching between execution and non-execution of the image composition is provided in the shape data display section 710a. In a case where the switch button 710e is operated by the user to execute the image composition, the shape data after the composition is displayed in the shape data display section 710a. On the other hand, in a case where the switch button 710e is operated by the user and the image composition is not executed, only the shape data measured by the measurement head 11 selected from among the four measurement heads 11A, 11B, 11C, and 11D is two-dimensionally and/or three-dimensionally displayed in the shape data display section 710a.

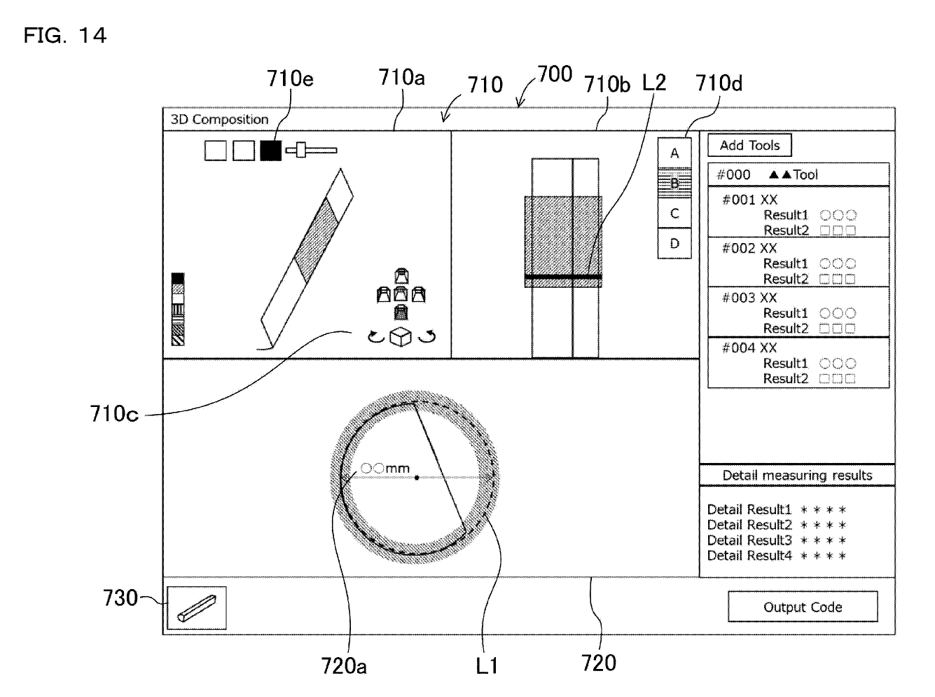

That is, a selection acceptance region 710d for selecting any measurement head from among the four measurement heads 11A, 11B, 11C, and 11D is provided in the individual image display section 710b. FIG. 14 illustrates a state where "B" is selected, that is, a state where the second measurement head 11B is selected by the user. In this case, when the switch button 710e is black and an operation of not executing the image composition is performed, the screen generation unit 33 displays only the shape data measured by the second measurement head 11B two-dimensionally and/or three-dimensionally in the shape data display section 710a. Although not illustrated, similarly, in a case where "A" is selected, only the shape data measured by the first measurement head 11A is displayed two-dimensionally and/or three-dimensionally in the shape data display section 710a. In a case where "C" is selected, only the shape data measured by the third measurement head 11C is displayed two-dimensionally and/or three-dimensionally in the shape data display section 710a. In a case where "D" is selected, only the shape data measured by the fourth measurement head 11D is displayed two-dimensionally and/or three-dimensionally in the shape data display section 710a.

As described above, the screen generation unit 33 generates a display screen capable of switching between a display aspect of simultaneously displaying the plurality of pieces of shape data corresponding to the plurality of measurement heads 11A, 11B, 11C, and 11D, as display targets of the first display region 710, and a display aspect of displaying individual pieces of shape data among the plurality of pieces of shape data, as the display targets. This processing is executed by the computer by the code generation support program.

On the other hand, the individual image display section 710b displays only the shape data measured by the measurement head 11 selected in the selection acceptance region 710d. FIG. 13 illustrates a state where "A" is selected, that is, a state where the first measurement head 11A is selected by the user. In this case, only the shape data measured by the first measurement head 11A is displayed in the individual image display section 710b. Similarly, in a case where "B" is selected, only the shape data measured by the second measurement head 11B is displayed in the individual image display section 710b, in a case where "C" is selected, only the shape data measured by the third measurement head 11C is displayed in the individual image display section 710b, and in a case where "D" is selected, only the shape data measured by the fourth measurement head 11D is displayed in the individual image display section 710b.

As described above, the screen generation unit 33 displays, in the first display region 710, the selection acceptance region 710d that accepts the selection of any measurement head 11 from among the plurality of measurement heads 11A, 11B, 11C, and 11D. Then, the screen generation unit 33 displays, in the individual image display section 710b, the shape data acquired by one measurement head 11 accepted in the selection acceptance region 710d, as the individual shape data.

In addition, the screen generation unit 33 generates a screen for three-dimensionally displaying the shape data corrected by the correction data generation unit 39 in a thumbnail format in a third display region 730 other than the first display region 710 and the second display region 720. The third display region 730 generated by the screen generation unit 33 can be provided, for example, below the first display region 710, below the second display region 720, or the like, and is a smaller region than the first display region 710 and the second display region 720. The shape data in the thumbnail format is displayed in the third display region 730, and thus, the user can easily grasp a schematic shape of the measuring object W.

As illustrated in FIG. 14, a cross-sectional shape of the shape data corrected by the correction data generation unit 39 is displayed in the second display region 720. Setting of a measurement element and setting of a measurement item can be performed in the second display region 720. The setting of the measurement element and the measurement item is a third phase illustrated in FIG. 5. The third phase corresponds to the determination in step S4 in the flowchart illustrated in FIG. 4, and in a case where it is determined to set a measurement condition, the processing proceeds to step S5 to start measurement condition setting processing. This setting processing is processing of setting one or more measurement elements and a measurement item using the one or more measurement elements, and is executed by the computer by the code generation support program.

On the other hand, in a case where it is determined not to set the measurement condition, the processing proceeds to step S6, and it is determined whether or not to perform position correction of the shape data. In a case where the position correction of the shape data is performed, the processing proceeds to step S3.

Step S5 can be executed by the measurement setting generation unit (setting unit) 38. That is, the cross-sectional shape is displayed in the second display region 720 illustrated in FIG. 14, and the measurement setting generation unit 38 sets one or more measurement elements and a measurement item using the one or more measurement elements for the cross-sectional shape of the shape data displayed in the second display region 720.

In the example illustrated in FIG. 14, since the measuring object W is a pipe having an arc-shaped wall portion, "circle" is set as the measurement element as indicated by a broken line L1. The measurement item is a distance. Specifically, a diameter of the circle which is the measurement element is set as the measurement item. In addition to the example illustrated in FIG. 14, for example, a plane or the like can be set as the measurement element. A height, a degree of flatness, an area, an angle, and the like can also be set as the measurement item.

The individual image display section 710b of the first display region 710 displays one or more measurement elements set by the measurement setting generation unit 38 on the shape data. The measurement element set by the measurement setting generation unit 38 is indicated by a solid line L2 in the individual image display section 710b. As a result, a position and a range of the measurement element can be confirmed in plan view.

In a case where the measurement element is a circle and the measurement item is a distance, since the pieces of shape data measured by the four measurement heads 11A, 11B, 11C, and 11D are required, the screen generation unit 33 displays an image obtained by composing the pieces of shape data measured by the four measurement heads 11A, 11B, 11C, and 11D in the first display region 710. In addition, in a case where the measurement element is a plane and the measurement item is a height, when the plane is set at a position measurable only by the first measurement head 11A, the screen generation unit 33 displays only the shape data measured by the first measurement head 11A in the first display region 710. Similarly, when the measurement item is set at a position measurable only by the second measurement head 11B, the screen generation unit 33 displays only the shape data measured by the second measurement head 11B in the first display region 710. In addition, when the measurement item is set at a position measurable only by the third measurement head 11C, the screen generation unit 33 displays only the shape data measured by the third measurement head 11C in the first display region 710. Further, when the measurement item is set at a position measurable only by the fourth measurement head 11D, the screen generation unit 33 displays only the shape data measured by the fourth measurement head 11D in the first display region 710. As described above, the screen generation unit 33 displays an image corresponding to the measurement item set by the measurement setting generation unit 38 in the first display region 710.

The execution unit 34 is a portion that executes inspection of the measurement item. Specifically, the execution unit 34 acquires the shape data received by the reception unit 21. The execution unit 34 specifies one or more measurement elements set by the measurement setting generation unit 38 for the shape data received by the reception unit 21. The execution unit 34 executes the inspection of the measurement item using one or more measurement elements set by the measurement setting generation unit 38. This processing is executed by the computer by the code generation support program.

For example, the execution unit 34 calculates values of one or more measurement items of the measuring object W based on the shape data received by the reception unit 21 and the text code and library stored in the storage unit 22. In a case where the measurement item is an item for measuring a physical quantity, the execution unit 34 measures a physical quantity such as a height, a degree of flatness, or a distance based on the measurement item.

As illustrated in FIG. 14, the screen generation unit 33 displays a result display element (measurement result) 720a of the measurement element calculated by the execution unit 34 in the second display region 720. In a case where the measurement item is a distance, the result display element 720a is displayed in the second display region 720 in the form of a composition of a numerical value and a unit. The result display element 720a may be superimposed and displayed on the cross-sectional shape of the shape data displayed in the second display region 720, or may be displayed at a portion deviated from the cross-sectional shape of the shape data.

In a case where it is determined not to perform the position correction of the shape data in step S6 of FIG. 4, the processing proceeds to step S7. In step S7, it is determined whether or not to generate a text code. The determination in step S7 is performed based on whether or not there is a command to generate the text code by the operation of the operation unit 14 by the user. Specifically, in a case where the user operates the operation unit 14 to give a code generation instruction, it is determined to generate the text code in step S7, and the processing proceeds to step S8. On the other hand, in a case where it is determined not to generate the text code in step S7, the processing proceeds to step S2.

In step S8, the code generation unit 37 generates a text code. Step S8 is a fourth phase of step S14 in the flowchart illustrated in FIG. 5. The code generation unit 37 specifies one or more measurement elements for the shape data and generates a text code for executing the inspection of the measurement item using the one or more measurement elements. This text code generation processing is executed by the computer by the code generation support program.

The text code generation processing is processing of generating a text code of the setting support information based on, for example, the correction information set in the correction setting processing of step S3, the measurement condition set in the measurement condition setting processing of step S5, and the like. The text code generation processing includes processing of outputting the library and the reference shape data together with the text code, that is, processing of outputting the setting support information. The text code generation processing is ended, and thus, the code generation support processing is ended.

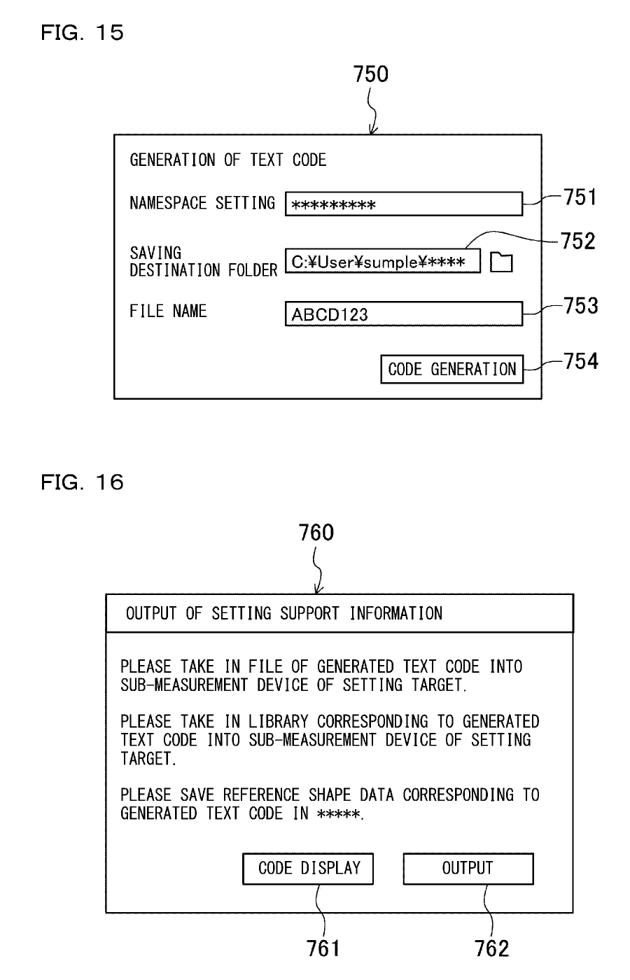

When the text code generation processing is started, the screen generation unit 33 generates a text code generation window 750 illustrated in FIG. 15 and displays this window on the display unit 13. A namespace input region 751, a folder input region 752, a file name input region 753, and a code generation button 754 are provided in the text code generation window 750. The namespace input region 751 is a region for setting a namespace for the generated text code. The folder input region 752 is an input field for determining an address of a folder or the like of a saving destination (output destination) of the generated text code. The file name input region 753 is a region for inputting a file name for identifying a file of the text code to be generated.

The user can input corresponding pieces of information for the text code to be created in the namespace input region 751, the folder input region 752, and the file name input region 753 of the text code generation window 750. A plurality of pieces of information input to the namespace input region 751, the folder input region 752, and the file name input region 753 of the text code generation window 750 can be referred to as pieces of file generation information.

The code generation button 754 is a button for giving a command to generate the file of the text code. After inputting the pieces of file generation information to the namespace input region 751, the folder input region 752, and the file name input region 753, the user operates the code generation button 754 via the operation unit 14. Then, the code generation unit 37 creates the file of the text code with a desired file name in a desired folder in the storage unit 22 illustrated in FIG. 3.

When the code generation button 754 is operated, the screen generation unit 33 generates an information output window 760 illustrated in FIG. 16 and displays this window on the display unit 13. In the information output window 760, a method of using a character string indicating the file of the text code, a library corresponding to the file, and reference shape data corresponding to the file is displayed.

In the information output window 760, a text code display button 761 and an output button 762 are displayed in addition to the character string indicating the using method. The user can operate the output button 762 after confirming the using method displayed in the information output window 760. When the output button 762 is operated, the information output window 760 is closed, and the setting support information is output to a predetermined output destination.

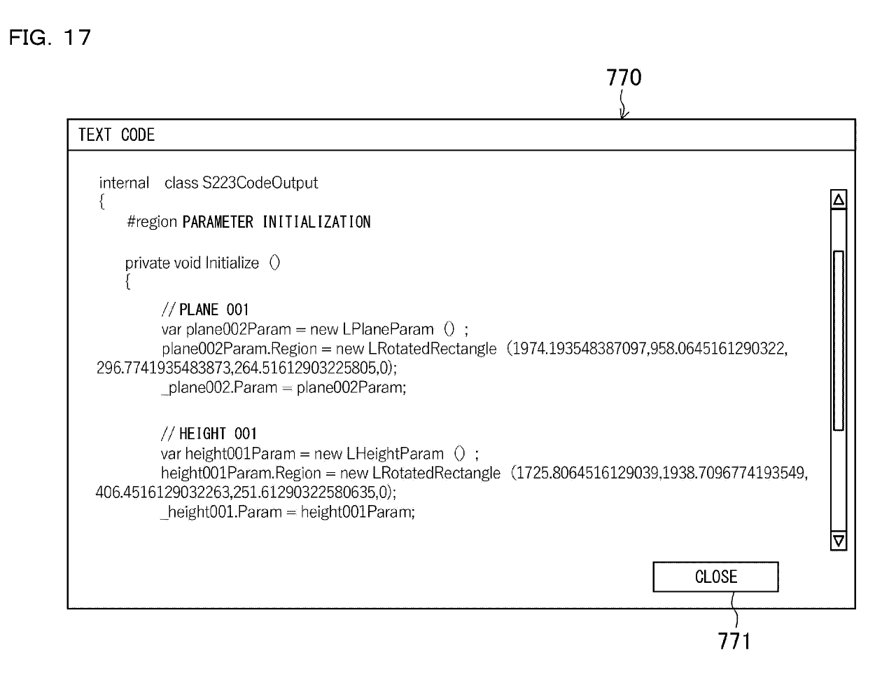

The text code display button 761 of the information output window 760 is a button for displaying contents of the generated text code on the display unit 13. When the text code display button 761 is operated, the screen generation unit 33 generates a text code display window 770 illustrated in FIG. 17 and displays this window on the display unit 13. In the text code display window 770, the text code created by the code generation unit 37 is displayed. As a result, the user can confirm the contents of the text code created by the code generation unit 37 on the screen of the display unit 13. The text code display window 770 displays a close button 771 for closing the text code display window 770.

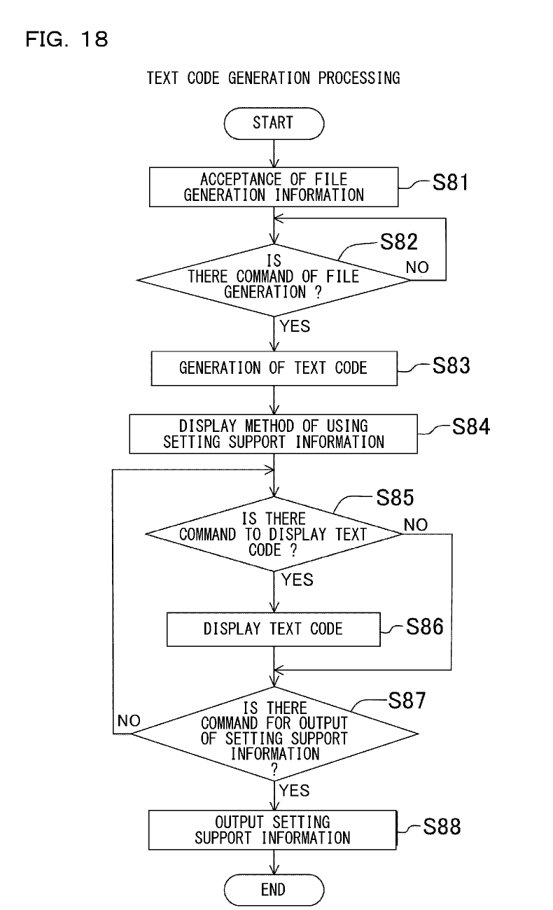

FIG. 18 is a flowchart illustrating a flow of the text code generation processing. When the text code generation processing is started, in step S81, the acceptance unit 36 in FIG. 3 accepts the file generation information. The file generation information is accepted based on the operation of the text code generation window 750 illustrated in FIG. 15.

In step S82, the acceptance unit 36 determines whether or not there is a command to generate the file of the text code. The determination in step S82 is performed based on, for example, whether or not the code generation button 754 of the text code generation window 750 illustrated in FIG. 15 is operated. In a case where there is no command to generate the file, the acceptance unit 36 repeats the processing of step S82. On the other hand, in a case where there is the command to generate the file, the processing proceeds to step S83, and the code generation unit 37 generates the file of the text code based on the file generation information accepted in step S81.

That is, in step S83, the code generation unit 37 generates character information indicating a processing program to be called from the library, as the processing program information, based on pieces of information (type of measurement item) of the plurality of set measurement items. In addition, the code generation unit 37 generates, as the designation information, character information indicating a parameter or the like obtained by designation by the user in association with each piece of processing program information. Further, the code generation unit 37 composes the processing program information and the designation information related to each other.

The library according to the present embodiment includes a processing program for setting a taking source of shape data (taking source setting) and setting processing for generating shape data (shape data generation processing setting). In a case where such a processing program is included, the code generation unit 37 can include, as a data taking condition, information indicating the taking source of the shape data and the taking pitch of the profile data in the text code. Note that, the library may not include the processing program for the taking source setting and the shape data generation processing setting. In a case where the library does not include the processing program for the taking source setting and the shape data generation processing setting, the code generation unit 37 does not include, as the data taking condition, the information indicating the taking source of the shape data and the taking pitch of the profile data set by the user in the text code. Therefore, the user sets these pieces of information by a separate setting work at the time of setting the sub-measurement device 20A.

The library may include a processing program related to the composition of the pieces of shape data. In this case, in a case where a composition condition of the plurality of pieces of shape data is set, the code generation unit 37 includes the composition condition in the text code. Note that, the library may not include the processing program related to the composition of the pieces of shape data. In this case, even though the composition condition of the plurality of pieces of shape data is set, the code generation unit 37 does not include the composition condition in the text code.

The code generation unit 37 may include, as measurement result information, information indicating the measurement result in the text code. According to the text code including the measurement result information, it is possible to easily grasp a measurement result to be noted. In a case where the measurement result information is included in the text code, the code generation unit 37 handles, as a structure, the measurement result information in the text code.

Specifically, the measurement result can include information (value, unit, and item name) of each measurement item such as "peak height", "bottom height", "average height", "peak height maximum value", "peak height minimum value", "bottom height maximum value", "bottom height minimum value", "average height maximum value", and "average height minimum value".

The value of each measurement item is of a floating-point number type, and the unit and the item name are of a character string type. Note that, a language of the item name may be selected in conjunction with a language used in the code generation support program, or a language different from the language used in the code generation support program may be selected. In the text code, the code generation unit 37 may specify the measurement result to be noted by a structure of the measurement result including the value, the unit, and the item name of each measurement item and an identifier for identifying the measurement item to be noted. For example, the measurement item to be noted may be specified from the structure of the measurement result including the value, the unit, and the item name of each measurement item by an enumerator (enum constant) of an enumeration type (enum type), as the identifier.

The library may include a processing program that executes a function that returns a measurement result corresponding to the measurement item to be noted from the structure of the processing result of the enumeration type using the enumerator as an argument. In addition, the function that returns the measurement result may include a function that outputs the measurement result as the floating-point number type and a function that outputs the measurement result as the character string indicating a value with a unit such as "mm". Further, the function that returns the measurement result may include a function that returns a character string indicating the item name using the enumerator as the argument. In this case, the code generation unit 37 can output the identifier such as the enumerator corresponding to the measurement item to be noticed, and generate the text code for acquiring the item name of the measurement item to be noticed and a value with a unit of the measurement result by using the identifier.

The library may include a processing program for executing processing for displaying the measurement result. The processing program may display the item name of the measurement item to be noted and the value with the unit of the measurement result in a list. In addition, the library may include a processing program that executes a function that returns image data in which a measurement result for every region of the set tool is displayed on the two-dimensional shape data or the three-dimensional shape data by using the shape data, a region of the tool, and the measurement result for every region as arguments.

In step S84, the screen generation unit 32 in FIG. 3 displays a method of using the setting support information (illustrated in FIG. 16). In step S85, the acceptance unit 36 determines whether there is a command to display the text code. The determination in step S85 is performed based on, for example, whether or not the text code display button 761 illustrated in FIG. 16 is operated. In a case where there is no command to display the text code, the processing proceeds to step S87. On the other hand, in a case where there is the command to display the text code, in step S86, the screen generation unit 32 displays the text code on the display unit 13 as illustrated in FIG. 17. The close button 771 is operated, and thus, the display of the text code is ended.

In step S87, the acceptance unit 36 determines whether or not a command about the output of the setting support information is given. The determination in step S87 is performed based on, for example, whether or not the output button 762 illustrated in FIG. 16 is operated. In a case where the command about the output of the setting support information is not given, the processing proceeds to step S85. On the other hand, in a case where the command about the output of the setting support information is given, in step S88, the output unit 35 associates the text code generated by the code generation unit 37 with the library and the reference shape data, and outputs the setting support information including the text code, the library, and the reference shape data. As a result, the text code generation processing is ended.

### Details of sub-measurement device

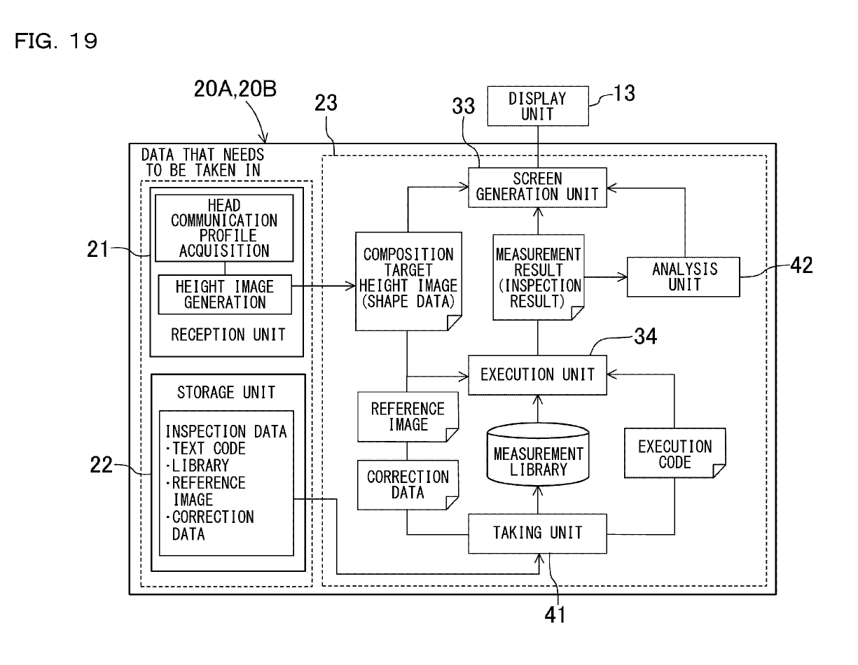

FIG. 19 is a block diagram illustrating a configuration of a control system of the sub-measurement device 20A or 20B illustrated in FIG. 1. As illustrated in FIG. 19, the control unit 23 of the sub-measurement device 20A or 20B according to the present embodiment includes the screen generation unit 33, the execution unit 34, a taking unit 41, and an analysis unit 42, as portions for measuring the shape of the measuring object W. The screen generation unit 33, the execution unit 34, the taking unit 41, and the analysis unit 42 are realized, for example, by the CPU of the control unit 23 of the sub-measurement device 20A or 20B executing a program for measuring the shape of the measuring object W stored in advance in the storage unit 22.

When the sub-measurement device 20A or 20B for measuring the shape of the measuring object W is set, the setting support information read from the storage unit 22 of the main measurement device 20 is input to the sub-measurement device 20A or 20B. The taking unit 41 reads the setting support information stored in the storage unit 22 and retains the library of the setting support information.

The reception unit 21 of the sub-measurement device 20A or 20B has the same configuration and function as the reception unit 21 of the main measurement device 20. The execution unit 34 executes the inspection of the measurement item using one or more measurement elements in the measuring object W based on the shape data received by the reception unit 21 and the text code and library read by the taking unit 41.

The analysis unit 42 performs various analyses based on the calculation result (measurement result) obtained by the execution unit 34. The screen generation unit 33 displays the image of the measuring object W on the display unit 13 based on the shape data received by the reception unit 21. In addition, the screen generation unit 33 displays the calculation result calculated by the execution unit 34 and the analysis result analyzed by the analysis unit 42 on the display unit 13.

The above-described embodiment is merely an example in all respects, and should not be construed in a limiting manner. Further, all modifications and changes falling within the equivalent scope of the claims are within the scope of the invention.

As described above, the code generation support device and the code generation support program according to the disclosure can be used in a case where shapes of various measuring objects are measured.

What is claimed is:

1. A code generation support device for an inspection device comprising:
a reception unit that receives pieces of shape data;
a correction unit that corrects each piece of shape data corresponding to each shape sensor of a plurality of shape sensors such that each piece of shape data becomes a common coordinate system based on a correction value corresponding to a position and a posture of each shape sensor;
a setting unit that sets one or more measurement elements and a measurement item using the one or more measurement elements;
an execution unit that specifies the one or more measurement elements set by the setting unit for the shape data received by the reception unit, and executes inspection of the measurement item using the one or more measurement elements set by the setting unit; and
a code generation unit that specifies the one or more measurement elements for the shape data, and generates a text code for executing the inspection of the measurement item using the one or more measurement elements; and
a screen generation unit that generates a display screen including a first display region that two-dimensionally and/or three-dimensionally displays the shape data corrected to the common coordinate system by the correction unit and displays the one or more measurement elements on the shape data, and a second display region that displays a cross-sectional shape of the shape data, the display screen being capable of switching between a display aspect of simultaneously displaying, as display targets of the first display region, a plurality of pieces of shape data corresponding to the plurality of shape sensors and a display aspect of displaying pieces of individual shape data among the plurality of pieces of shape data.

2. The code generation support device according to claim 1,
wherein the setting unit accepts at least designation of a position for the cross-sectional shape of the shape data displayed in the second display region, and sets the measurement element and the measurement item corresponding to the position for the cross-sectional shape.

3. The code generation support device according to claim 2,
wherein the screen generation unit displays a measurement result of the measurement element, in the second display region, together with the cross-sectional shape of the shape data and an image corresponding to the measurement element set for the cross-sectional shape.

4. The code generation support device according to claim 1,
wherein the screen generation unit displays an image corresponding to the measurement item set by the setting unit in the first display region.

5. The code generation support device according to claim 1,
wherein the screen generation unit generates a correction value display screen that displays the correction value.

6. The code generation support device according to claim 5,
wherein the correction unit accepts adjustment of the correction value displayed on the correction value display screen.

7. The code generation support device according to claim 1,
wherein the correction unit is configured to be able to calculate the correction value corresponding to the position and posture of each shape sensor by an alignment tool, and write the calculated correction value as binary correction data corresponding to the text code generated by the code generation unit.

8. The code generation support device according to claim 1,
wherein the correction unit calculates the correction value corresponding to the position and posture of each shape sensor by an alignment tool, and automatically corrects the shape data corresponding to each shape sensor based on the calculated correction value.

9. The code generation support device according to claim 1,
wherein the screen generation unit displays a selection acceptance region that accepts selection of any one shape sensor from among the plurality of shape sensors in the first display region, and displays, as the individual shape data, shape data acquired by the one shape sensor accepted in the selection acceptance region in the first display region.

10. The code generation support device according to claim 1,
wherein the screen generation unit generates a screen for three-dimensionally displaying shape data based on the shape data corrected by the correction unit in a thumbnail format in a region other than the first display region and the second display region.

11. A computer-implemented method for code generation support, the method comprising:
receiving pieces of shape data;
correcting shape data corresponding to each shape sensor of a plurality of shape sensors based on a correction value corresponding to a position and a posture of each shape sensor;
setting one or more measurement elements and a measurement item using the one or more measurement elements;
specifying the set one or more measurement elements for the received shape data and executing inspection of the measurement item using the set one or more measurement elements;
specifying the one or more measurement elements for the shape data and generating a text code for executing the inspection of the measurement item using the one or more measurement elements; and
generating a display screen including a first display region that two-dimensionally and/or three-dimensionally displays the corrected shape data, and displays the one or more measurement elements on the shape data, and a second display region that displays a cross-sectional shape of the shape data, the display screen being capable of switching between a display aspect of simultaneously displaying, as display targets of the first display region, a plurality of pieces of shape data corresponding to the plurality of shape sensors and a display aspect of displaying pieces of individual shape data among the plurality of pieces of shape data.

12. A non-transitory computer-readable storage medium storing instructions that, when executed by a processor, cause a computer to perform a process comprising:
receiving pieces of shape data;
correcting shape data corresponding to each shape sensor of a plurality of shape sensors based on a correction value corresponding to a position and a posture of each shape sensor;
setting one or more measurement elements and a measurement item using the one or more measurement elements;
specifying the set one or more measurement elements for the received shape data and executing inspection of the measurement item using the set one or more measurement elements;
specifying the one or more measurement elements for the shape data and generating a text code for executing the inspection of the measurement item using the one or more measurement elements; and
generating a display screen including a first display region that two-dimensionally and/or three-dimensionally displays the corrected shape data, and displays the one or more measurement elements on the shape data, and a second display region that displays a cross-sectional shape of the shape data, the display screen being capable of switching between a display aspect of simultaneously displaying, as display targets of the first display region, a plurality of pieces of shape data corresponding to the plurality of shape sensors and a display aspect of displaying pieces of individual shape data among the plurality of pieces of shape data.
